(19) United States
(12) Patent Application Publication
(10) Pub. No.: US 2007/0283388 A1
(43) Pub. Date: Dec. 6, 2007

(54) Ad Scheduling Systems and Methods

(76) Inventors: David J. Del Beccaro, Jenkinown, PA (US); Christina B. Tancredi, Ambler, PA (US); Siamak Behta, Watertown, MA (US); Jeremy C. Rosenberg, Havre de Grace, MD (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/742,116

(22) Filed: Apr. 30, 2007

Related U.S. Application Data
(60) Provisional application No. 60/795,565, filed on Apr. 28, 2006.

(51) Int. Cl. H04N 7/025

(52) U.S. Cl. 725/35

(57) ABSTRACT

In one aspect, the present invention provides systems and methods for facilitating the scheduling of ads across multiple services.

This application claims the benefit of U.S. Provisional Patent Application No. 60/795,565, filed on Apr. 28, 2006. The above referenced provisional patent application is incorporated herein by this reference.

### BACKGROUND

1. Field of the Invention

The present invention relates to systems and methods for advertisement management.

2. Discussion of the Background

A traditional content programmer would program content for a single content service (e.g., a broadcast radio service or broadcast tv service). Today, however, some content programmers, such as Music Choice, program content for multiple services. A challenge these programmers face is how to schedule advertisements (“ads”) effectively across the multiple services.

### SUMMARY

The present invention provides system and methods for facilitating the scheduling of ads across multiple services of an entertainment system.

One embodiment of the invention provides an entertainment system that includes: a first server for providing a first service, the first service comprising transmitting graphical content assets over a first network to a device or devices in communication with the first network; a second server for providing a second service, the second service comprising transmitting graphical content assets over a second network to a device or devices in communication with the second network; and an ad scheduling system configured to, among other things, schedule an advertisement for the first service. The ad scheduling system may be further configured to: obtain viewership information for the second service; predict the number of impression for the advertisement on the first service based on the viewership information for the second service; and determine whether the advertisement should be reconfigured based on the predicted number of impressions.

In another embodiment of the invention, there is provided an ad scheduling method that includes the steps of: configuring an ad to run on a first content service; obtaining viewership information for a second content service; predicting the number of impression for said ad on the first service based on the viewership information corresponding to the second service; and determining whether to reconfigure the ad based on the predicted number of impressions.

In another embodiment of the invention, there is provided an ad scheduling method that includes the steps of: receiving an ad from an advertiser; receiving information from the advertiser indicating that the ad may be treated as a run-of-service (ROS) ad; for each of the plurality of services, scheduling a set of non-ROS ads to run on the service according to media plans associated with the non-ROS ads; and after scheduling the non-ROS ads: (a) determining the available ad inventory for each service; (b) selecting from amongst the available services a service having a relatively large amount of inventory; and (c) allocating a number of impressions for the ROS ad to the selected service to thereby balance the ad inventory across the plurality of services.

In another aspect, the invention provides an asset selection method, which method includes: selecting an advertisement, the selected advertisement being associated with meta-data; transmitting the selected advertisement to one or more client devices; after selecting the advertisement, selecting a graphical content asset, wherein the selection of the graphical content asset is based, at least in part, on the meta-data associated with the selected advertisement; and after selecting the graphical content asset, transmitting the graphical content asset to the one or more client devices. The meta-data may include information concerning a subject matter of the advertisement (e.g., information identifying and/or concerning a product/service advertised by the advertisement).

The above and other embodiments of the present invention are described below with reference to the accompanying drawings.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements.

FIG. 1 illustrates an entertainment system according to an embodiment of the invention.

FIG. 2 illustrates an advertisement scheduling process.

FIG. 3 illustrates a graphical user interface.

FIG. 4 illustrates a graphical user interface.

FIG. 5 a media plan creation graphical user interface.

FIG. 6 is a flow chart illustrating a process, according to one embodiment, for load balancing advertisements across multiple services.

FIG. 7 illustrates an example set of placement rules that may be associated with a specific ad.

FIG. 8 is a flow chart illustrating an ad selection process.

### DETAILED DESCRIPTION OF PREFERRED EMBODIMENTS

As used herein, the words “a” and “an” mean “one or more.”

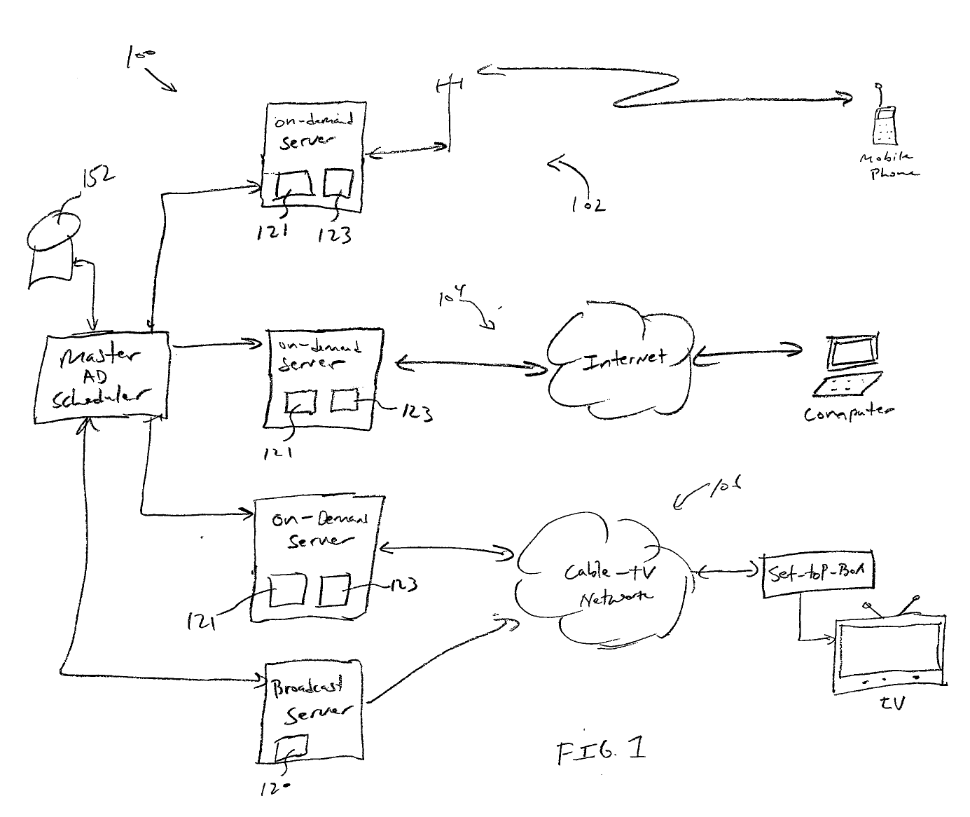

FIG. 1 illustrates an entertainment system 100 according to an embodiment of the invention. As shown in FIG. 1, system 100 may include multiple content delivery platforms. In the example shown, there are three content delivery platforms: a mobile phone network platform 102, an Internet platform 104, and a digital cable TV platform 106. Each content delivery platform may have one or more content services (e.g., a broadcast service and an on-demand service). Accordingly, each content delivery platform may have a broadcast server 108 for broadcasting content over multiple broadcast channels and/or an on-demand server 109 for transmitting content to a user in response to the user requesting the content. Typically, the broadcast channels are based on a music genre. For example, servers 108 may broadcast a Rock channel, a Classical channel, and a Jazz channel using platform 102, 104 and 106, respectively. As used herein a “server” is a computer system that may consist of one or more computers.

Servers 108 may include a content selector 120, which may function to select the content (e.g., music video, advertisements and/or other content) that is transmitted over each channel. The selection may be based on a schedule (e.g., rules). Server 109 may include an ad selector 121, which may function to select advertisements in response to a user requesting a particular content (e.g., a music video) from the server 109. Selector 121 may select advertisements based on rules.

As further illustrated in FIG. 1, system 100 may include a master ad scheduling system 150. Scheduling system 150 is configured to enable a user to schedule ads across all of the available services on each platform. This is a useful feature because some advertisers may want to run some of its ads on more than service. For example, one advertiser may want to have a specific ad run on the broadcast mobile service only, whereas another advertiser may want to have a specific ad run on all the available services.

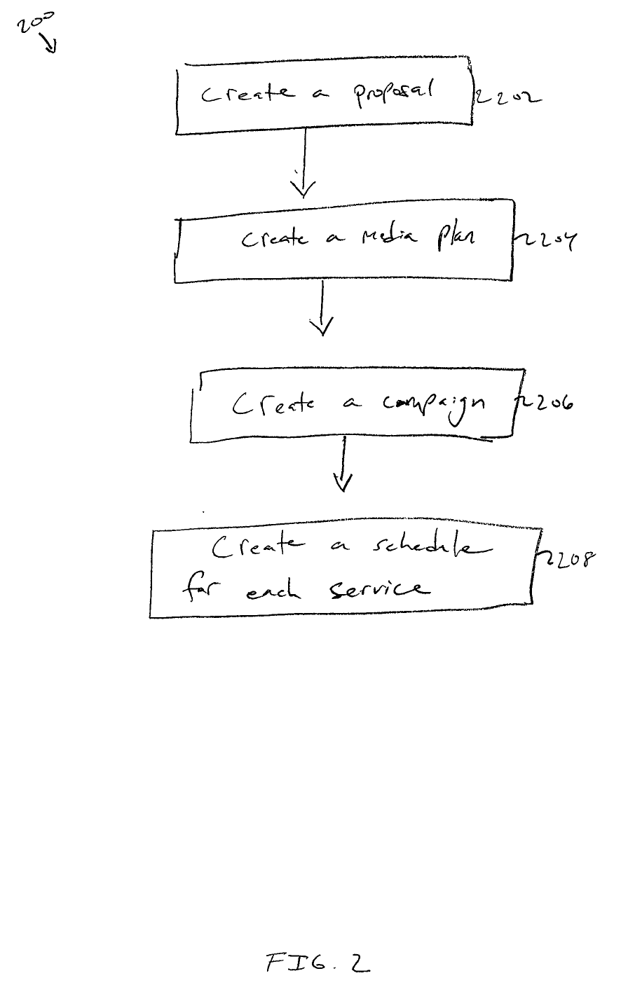

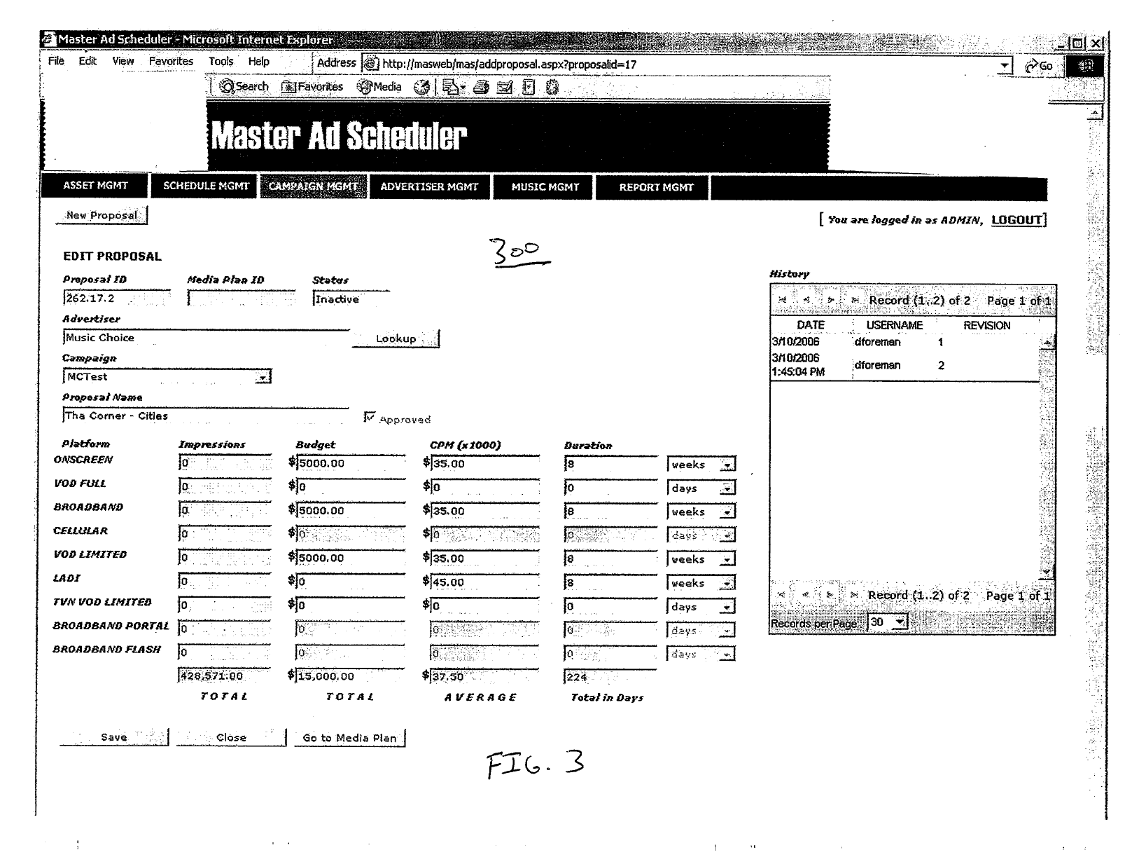

FIG. 2 illustrates an advertisement scheduling process 200 for scheduling a specific advertisement. Process 200 may begin in step 202. In step 202 a proposal is created. Scheduling system 150 may include software for facilitating the creation of the proposal. FIG. 3 illustrates a graphical user interface 300, which may be generated by the software, for facilitating the creation of the proposal.

User interface 300 is designed to be used by an employee (or “ad manager”) of the content programmer. The ad manager receives information about the proposal from the advertiser and uses interface 300 to input the information into system 150, which may store the information in a proposal database 152. As illustrated in FIG. 3, a proposal, in some embodiments, is a set of information that may include the following: the services on which the advertiser would like the advertisement to run, a dollar budget or number of impressions for each service, and a duration (i.e., for how long should the ad run).

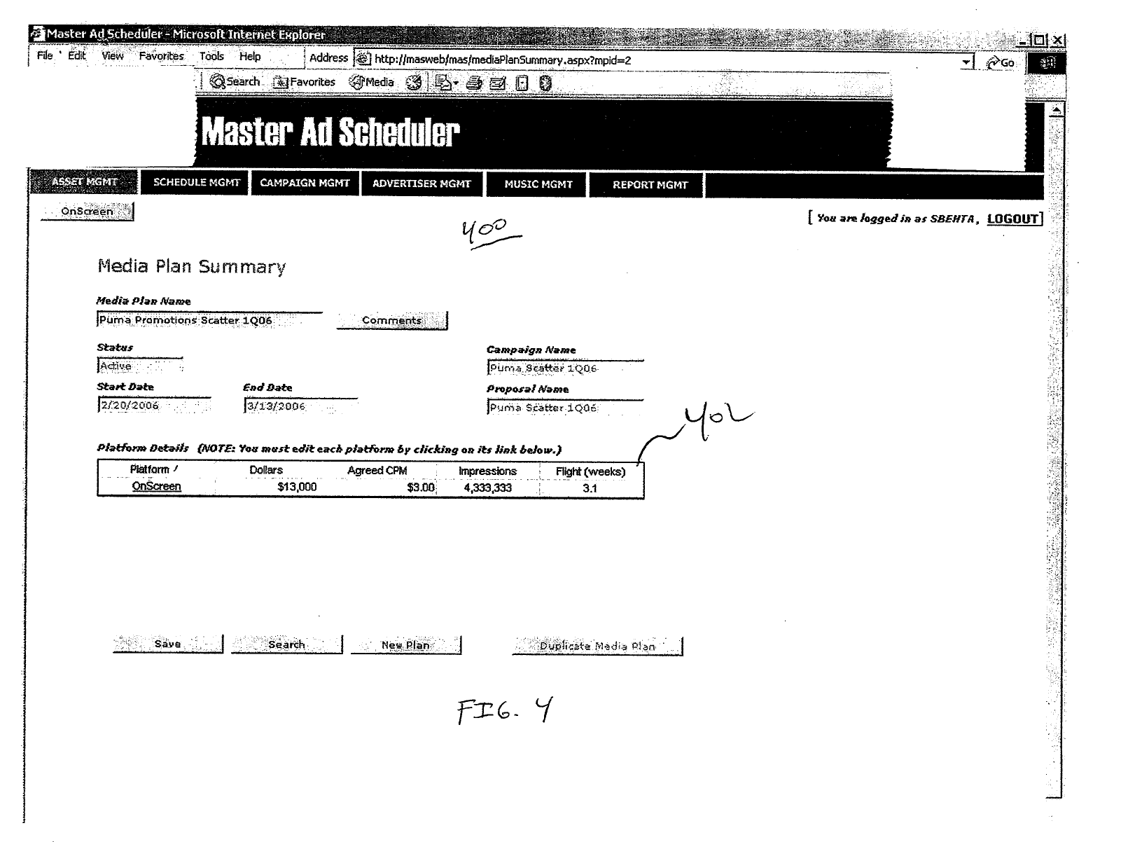

After the proposal is specified, the next step (step 204) is to create a media plan based on the proposal. Scheduling system 150 may include software for facilitating the creation of the media plan. FIG. 4 illustrates a graphical user interface 400, which may be generated by the software, for facilitating the creation of the media plan. Interface 400 displays a media plan summary. In the embodiment shown, interface 400 displays a list 402 of the services that were selected in the proposal creation stage. In the example shown, only the “OnScreen” service was chosen, which service is a broadcast service over the digital cable platform. If other services were chosen, an entry for each of the other platforms would appear in list 402.

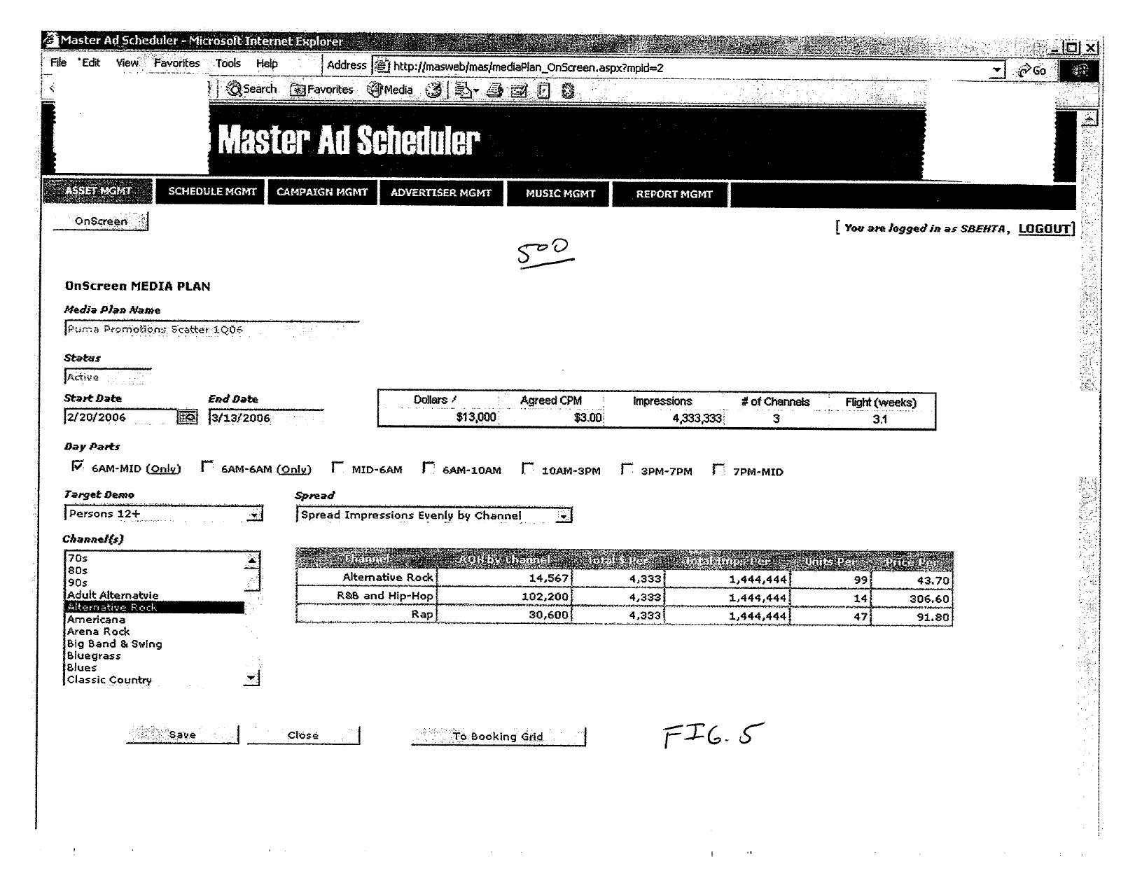

From interface 400, the user can specify a specific media plan for each service in the list 402. To do this, the user would select the hyperlink associated with the service in list 402. In response to the user selecting the hyperlink, a media plan creation interface 500 (see FIG. 5) may be displayed. Interface 500 enables the user to specify a media plan for the selected service.

As illustrated in FIG. 5, a media plan for a service, in some embodiments, consists of a set of information that may include the following: start and end dates, day part specifications, target demographic, impression spread information, a list of channels or genres. A media plan may include other information as well, such as attract and repel rules. For example, an advertiser could specify that it wants its ad “attracted” to certain genres, albums, artists, etc and “repelled” from other genres, albums, artists, etc. These rules and the other media plan information may be used to schedule the ad.

In the next step (step 206), once the media plans for the ad have been approved, a campaign is created based on the media plans. In some embodiments, campaign creation includes creating a flowchart or campaign grid of how the ad will run. A flowchart or campaign grid is a weekly breakdown of target impressions per genre/channel for each service. The flowchart or grid may show per-channel totals and per-week totals.

In the last step (step 208), once a campaign has been approved, individual schedules for each service may be created. The following information may facilitate schedule creation: usage forecasts, available inventory, and a pricing model. Usage forecasts may be based, at least in part, on internal usage/play data from each service (e.g., actual historical usage data from each service) along with external statistical information (e.g., Arbitron data). Available inventory may be determined based, at least in part, on future committed and reserved schedules.

In some cases, an advertiser will have an ad it would like to run for some duration and the advertiser does not have a preference for the service on which the ad will run (such an ad may be referred to as a run-of-service (ROS) ad). For example, the advertiser may simply want a certain number of impressions for the ROS ad, but does not care how those impressions are achieved. In such situations, the ROS ad can be used to balance the advertising load across all of the available services.

For example, if during the period that the advertiser wants the ROS ad to run a first service has very little inventory available, but a second service has a large amount of available inventory, then the ad scheduling system will assign the ROS ad to the available inventory of the second service, thereby balancing the advertising load. Thus, there is a distinct advantage to having an ad scheduling system that is aware of the available ad inventory across all of the available services.

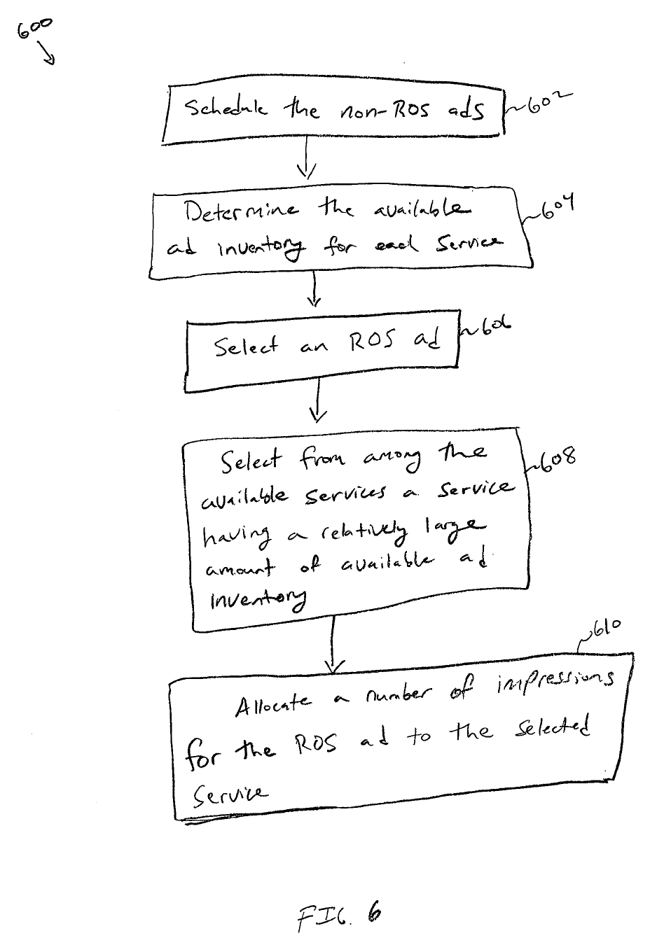

Referring now to FIG. 6, FIG. 6 is a flow chart illustrating a process 600 according to one embodiment for load balancing advertisements across multiple services. Process 600 may begin in step 602, where a set of non-ROS ads are scheduled to run on the available services according to the media plan that was created for each of the non-ROS ads. In step 604, after scheduling the non-ROS ads, the available ad inventory for each available service is determined. In step 606, a ROS ad is selected. In step 608, a service having a relatively large amount of inventory is selected from amongst the available services. In step 610, a number of impressions for the ROS add is allocated to the service selected in step 608. In this manner, the ROS ads can be used to fill-up available inventory on any one of the available services.

With respect on-demand services (as opposed to programmed broadcast services), the content programmer has little or no control over when a specific graphic content asset (e.g., music video, music, concert, interview or other content asset) will be requested by a user from the on-demand server 109. Accordingly, the scheduling of ads in an on-demand service can be difficult

For example, in some cases, the decision of which ad to associate to a particular graphic content requested by a user must be done almost completely in real-time, on the fly. Thus, in some embodiments, an ad selector 121 is involved in ad selection, even when the user is working interactively with an on-demand server 109 to simply select a music video to watch.

In order for selector 121 to have enough information to make valid ad selection decisions, it may be necessary for each graphic content asset that may be selected by the user to have association information about it stored in a place accessible to selector 121, so that this association information can be used by selector 121 at the time a user selects a graphic content from the on-demand server 109.

A graphic content asset can (and probably will) have multiple associations (e.g., based on what products or services are shown in the video asset). Product and service associations may need to be recorded in the database for music video, concert, and interview assets, due the possibility of product placements in the assets themselves (e.g., Coca-Cola may not want one of its ads to run immediately after a concert with a large Pepsi billboard in view on the back of the stage). The associations that a graphic content asset can have may be segregated into a variety of categories (e.g., artist, product, vendor, etc. . . . ).

In deciding which ad to run in response to a user selecting a specific graphic content asset, the selector 121 may use placement rules associated with the available ads and the association information associated with the selected graphic content asset.

In some embodiments, there are three types of rules. First, there are ‘attract’ rules—rules that would cause an ad to get associated (and therefore played) with a particular graphic content asset or group of assets. Second, there are ‘repel’ rules—rules that would cause an ad to never be associated with a particular video asset or group of assets. Third, there are ‘time-based’ rules—rules that govern the time of day and frequency of how often an ad should run. New categories, and rules referencing those categories can be added to the database as new graphic content assets or ads are added to the system.

For the most part, placement rules will be associated with each available ad, to allow the ads to be evaluated for insertion when a particular graphic content asset (e.g., music video, concert, interview or other asset) has been selected for play. However, in addition to ads having ‘attract’ and ‘repel’ rules, any graphic content asset can also have such rules. This will allow the graphic content asset itself to dictate what kinds of ads are to be linked with it. This would be useful for situations where an artist has exclusive associations with a product (like Britney Spears with Pepsi).

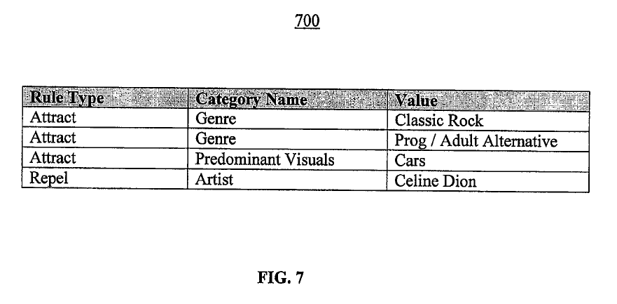

FIG. 7 illustrates an example set of placement rules 700 that may be associated with a specific ad. The example rules shown in FIG. 7 illustrate some of the ways in which an ad can be associated with various graphic content assets.

Based on the placement rules shown in FIG. 7, the ad associated with these rules will be a candidate for insertion when the graphic content to be played is in the Classic Rock or Progressive genre, and contains a predominant number of car images, but it will not be a candidate if the video is by Celine Dion.

The “predominant visuals” category may not have existed before the ad was put into the asset database. Once a decision was made to attract the ad to videos containing car images, the category would be added to the database, and the ‘attract to cars’ rule added to the ad. A review of the graphic content assets in the inventory would have to be conducted, and those that had a predominant number of car images would be tagged with a category of ‘Predominant Visuals’ and a value of ‘Cars’.

In addition to selecting an ad based on the selection of a graphical content asset, the invention contemplates selecting a graphical content asset based on a selected ad. For example, an advertisement may be selected for transmission to a user or users and, then, based, at least in part, on the ad selected, a graphic content asset mat be selected for transmission to the user or users. The selected graphic content asset may be transmitted some time before (e.g., immediately before) or some time after (e.g., immediately after) the ad is transmitted to the user or users. To facilitate the selection of graphic content asset(s) based on the selection of an ad, the graphic content asset may have one or more placement rules and the ad may have association information associated with the ad, which rules and association information may be used in selecting the graphic content asset based on the selected ad.

The placement rules associated with an asset may be delivered to the on-demand server 109 with the asset as meta-data, so that the rules will be available to the selector 121. That is, in some embodiments, in order to be useful to the selector software 121 running on the server 109, the category associations and placement rules that have been specified for graphic content assets and advertising assets must be delivered to the server 109 with the assets themselves. This means that, in some embodiments, the category associations and placement rules must be incorporated into the meta-data file that is delivered to server 109 with the asset.

In some embodiments, to be inserted into the meta-data file for the asset, the information will have to be encoded into ASCII strings that can serve as the value attribute string of the predetermined tag (e.g., the “episode_name” tag). Preferably, the tag used is a tag that is not processed by the user's client device (e.g., set-top-box). To facilitate the coding, in some embodiments, each category is given a short identifier (e.g., the “predominant visuals” category may be given the following id: “723”).

In some embodiments, the ASCII string representing a category association for an asset will consist of the following characters in sequence: the character ‘C’ followed by the category ID value followed by a colon followed by the object ID value. For example, assume an asset database contained a definition for a category called “predominant visuals” with a category ID value of 723, and a definition for an object called “cars” in the category with an object ID of 391. Further assume that a graphic content asset has been associated with the “predominant visuals:cars” category/object combination. For such an association, the meta-data for that graphic content asset would include the string: “C723:391”.

In some embodiments, the string representing an placement rule for an ad will consist of the following characters in sequence: the character ‘A’ (for Attract) or ‘R’ (for Repel) followed by the category ID value followed by a colon followed by the object ID value followed by a colon followed by a rule priority. Assuming the association database contained the same “predominant visuals:cars” category/object definitions as described above, an automobile advertisement would have an attract rule to graphic content assets that had an association indicating that their “predominant visual” was “cars.” For such an attract rule, the meta-data for that advertisement would contain the string “A723:391:2”.

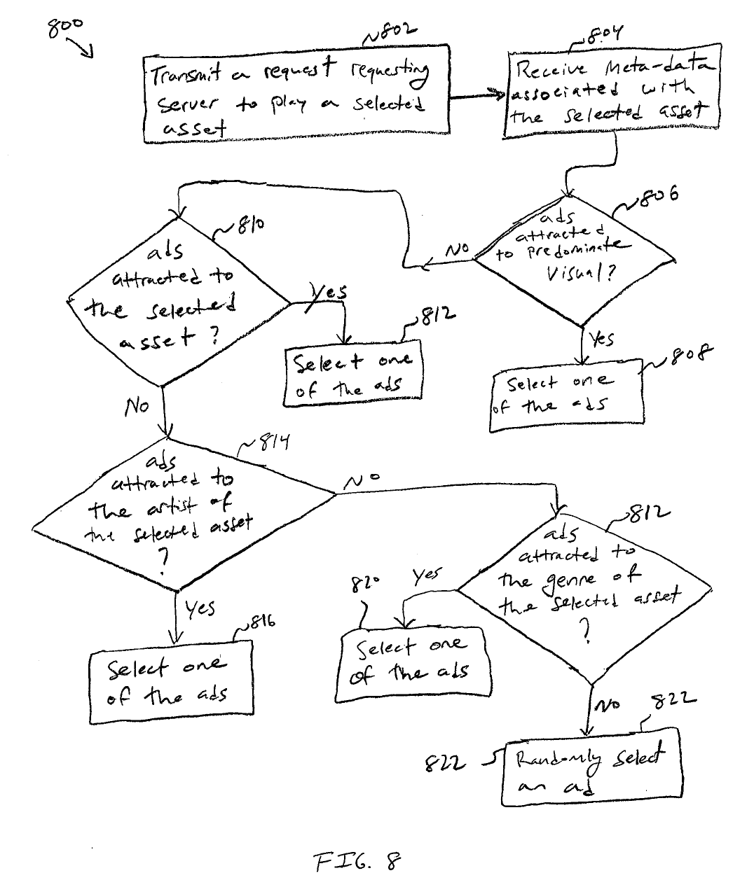

Referring now to FIG. 8, FIG. 8 is a flow chart illustrating a process 800, according to one embodiment, for selecting an ad in response to a user requesting sever 109 to play a user selected asset.

Process 800 may being in step 802 where a user transmits a request to server 109 requesting the server 109 to play a user selected graphic content asset (e.g., music video). In step 804, selector 121 receives meta-data associated with the selected graphic content asset (for this example, we will assume the meta-data includes information indicating that the graphic content asset has a particular predominate visual, a title, an artist, and a genre). In step 806, selector determines whether any of a set of available ads is “attracted” to the predominate visual. If yes, then selector 121 selects one of the ads that is attracted to the predominate visual (step 808), otherwise the process may proceed to step 810. In step 810, selector 121 determines whether any of the available ads is “attracted” to the title. If yes, then selector 121 selects one of these ads (step 812), otherwise the process may proceed to step 814. In step 814, selector 121 determines whether any of the available ads is “attracted” to the artist. If yes, then selector 121 selects one of these ads (step 816), otherwise the process may proceed to step 818. In step 818, selector 121 determines whether any of the available ads is “attracted” to the genre. If yes, then selector 121 selects one of these ads (step 820), otherwise the process may proceed to step 822. In step 822, selector 121 may randomly select an ad from the available set of ads.

In some embodiments, it not possible or practical to select an ad on the fly in response to a user requesting an asset. Thus, in some of these embodiments, each ad is linked with an asset prior to the user selecting the asset. In some cases an ad can be linked with an asset prior to the asset being added the on-demand server's asset library 123. Thus, when a user selects the asset, the linked ad is automatically shown to the user (i.e., the selection of the ad is done a head of time, as opposed to in real time).

A difficulty a content programmer faces when scheduling ads is ensuring that number of impressions for the ad specified by the advertiser is achieved. For example, as discussed above, scheduling ads in an on-demand service may be difficult because the content programmer may have no way of knowing a head of time which graphic content assets its user are going to select and this can lead to some ads being over-selected and some being under-selected, but the problem is not limited to on-demand services. For example, some ads may be scheduled such that they are shown only when a certain graphic content asset or type of graphic content asset is transmitted and these ads my not meet their impression goals if users do not request or watch the certain graphic content asset or type of graphic content.

Accordingly, a content programmer should occasionally or periodically adjust the ad schedules to ensure that the available ads are meeting the impression goals set by the advertisers. However, in order to intelligently reschedule an ad, the content programmer needs accurate data regarding the number of impressions for the ad to date. For some services, this information may be readily available, but for other services the content programmer may have know way of determining in real-time the number of impressions for any given ad in a given period.

Thus, in some embodiments, the scheduling system may use historical information to estimate the current level of impressions for a given asset. Additionally or alternatively, in some embodiments, the scheduling system may use information from one service (e.g., broadcast mobile service) to calculate the number of impression for an ad scheduled on another service. Depending on the outcome of this calculated prediction, the ad may need to be rescheduled. For example, if the calculation shows that the number of impression is far from the target number of impressions, then the ad should be rescheduled.

As a concrete example, assume an ad is linked only with a certain music video on a specific service such that that ad is played only when the certain music video is played by the specific service. Further assume that, for whatever reason, the content programmer has no way of knowing in a timely fashion exactly how many users of the service actually watch the certain music video when it is played by the service. In such a situation, the content programmer will not know the true number of impressions for that ad. However, because the content programmer provides more than one service, the content programmer can use information from one of the other services to predict the number of impressions for the ad. For example, assume that the content programmer knows that the music video has been requested X number of times within the previous week by users of the other service. Using this information and historical information correlating requests on the other service with impressions on the first service, the content programmer may be able to predict the number of impressions (of course, the prediction will be only as good as the correlation data). Based on the predicted number of impressions, the content programmer may wish to reschedule the ad (e.g., link the ad with one or more other music videos or other genres of music videos).

In one embodiment, a first mechanism is used to predict impression for the first several weeks (e.g., 4 weeks) and a second mechanism is used to after week 4 (or N) of the life of the content. The first prediction may be based on opening estimates of usage (to be replaced by actual numbers once available) and applies a viewing decay curve based on aggregate historical behavior of assets with similar starting levels of activity (e.g., opening view of less than 15 K, 15 K-75 K, 75 K-200 K, over 200 K). The appropriate decay curve is applied to the opening activity number to predict the day to day activity of the asset over the initial period (4 weeks, in one embodiment).

After the 4 weeks, of exposure, the second mechanism is used to predict subsequent activity. The second mechanism uses the actual activity levels of the most recent time periods to determine a rate of increase or decrease (slope of the line between the two points) and uses that ‘slope’ to predict future activity starting at the most recent time period for which there is actual usage data.

Accordingly, future usage predictions can be made based on historical activity on the non-reporting platform or a correlation can be developed between platforms (platform 1 usage is x% of platform 2) and that correlation can be applied to predictions built for the platform which is reporting.

While various embodiments/variations of the present invention have been described above, it should be understood that they have been presented by way of example only, and not limitation. Thus, the breadth and scope of the present invention should not be limited by any of the above-described exemplary embodiments.

Additionally, while the processes described above and illustrated in the drawings are shown as a sequence of steps, this was done solely for the sake of illustration. Accordingly, it is contemplated that some steps may be added, some steps may be omitted, and the order of the steps may be re-arranged.

What is claimed is:

1. An entertainment system, comprising:
a first server for providing a first service, said first service comprising transmitting graphical content assets over a first network to a device or devices in communication with the first network;
a second server for providing a second service, said second service comprising transmitting graphical content assets over a second network to a device or devices in communication with the second network; and
an ad scheduling system configured to schedule an advertisement for the first service, wherein
the ad scheduling system is further configured to:
obtain viewership information for the second service;
predict the number of impression for said advertisement on the first service based on the viewership information for the second service; and
determine whether the advertisement should be reconfigured based on the predicted number of impressions.

2. The system of claim 1, wherein the ad scheduling system is further operable to reconfigure the advertisement if the ad scheduling system determines that the advertisement should be reconfigured.

3. The system of claim 1, wherein the ad scheduling system schedules the advertisement by linking the advertisement with a first graphic content asset and/or with a first type of graphic content asset.

4. The system of claim 3, wherein the ad scheduling system is further operable to reconfigure the advertisement by linking the advertisement with a second graphic content asset and/or with a second type of graphic content asset if the ad scheduling system determines that the advertisement should be reconfigured.

5. The system of claim 4, wherein the viewership information comprises data corresponding to the number of people who requested or watched the first graphic content asset using the second service.

6. The system of claim 1, wherein the first network is a cable-tv network.

7. The system of claim 6, wherein the second network is the Internet or a mobile telephone network.

8. The system of claim 6, wherein the first server is an on-demand server.

9. The system of claim 1, further comprising a database for storing a placement rule and associating the placement rule with the advertisement.

10. The system of claim 9, wherein the placement rule specifies that the advertisement is attracted to a specific graphic content asset and/or type of graphic content asset.

11. The system of claim 1, wherein the ad scheduling system is configured to use decay curves to predict the number of impression for said advertisement on the first service based on the viewership information for the second service.

12. An ad scheduling method, comprising:
configuring an ad to run on a first content service;
obtaining viewership information for a second content service;
predicting the number of impression for said ad on the first service based on the viewership information corresponding to the second service; and
determining whether to reconfigure the ad based on the predicted number of impressions.

13. The method of claim 12, further comprising reconfiguring the advertisement if a determination is made that the advertisement should be reconfigured.

14. The method of claim 13, wherein the first service comprises a set of graphic content assets and the act of configuring the ad to run on the first service comprises linking the ad with a first graphic content asset from said set.

15. The method of claim 14, wherein the act of reconfiguring the ad comprises linking the advertisement with a second graphic content asset.

16. The method of claim 15, wherein the viewership information comprises data corresponding to the number of people who requested or watched the first graphic content asset using the second service.

17. The method of claim 12, wherein the first service provides content to users by transmitting content using a first server coupled to a first network, and the second service provides content to users by transmitting content using a second server coupled to the first network or a second network.

18. The method of claim 17, wherein the first network is a cable-tv network.

19. The method of claim 18, wherein the second network is the Internet or a mobile telephone network.

20. The method of claim 12, further storing a placement rule and associating the placement rule with the ad.

21. The method of claim 20, wherein the placement rule specifies that the ad is attracted to graphic content assets that have a particular predominate visual.

22. The method of claim 12, wherein the act of predicting the number of impression for said ad on the first service based on the viewership information corresponding to the second service comprises using a decay curves make the prediction.

23. In an entertainment system providing a plurality of services, a method for scheduling ads, the method comprising:
receiving an ad from an advertiser;
receiving information from the advertiser indicating that the ad may be treated as a run-of-service (ROS) ad;
for each of the plurality of services, scheduling a set of non-ROS ads to run on the service according to media plans associated with the non-ROS ads; and
after scheduling the non-ROS ads:
(a) determining the available ad inventory for each service;
(b) selecting from amongst the available services a service having a relatively large amount of inventory; and
(c) allocating a number of impressions for the ROS ad to the selected service to thereby balance the ad inventory across the plurality of services.

24. The method of claim 23, prior to scheduling a non-ROS ad to run on a service, creating a proposal for the non-ROS ad.

25. The method of claim 24, wherein the act of creating the proposal for the non-ROS ad comprises specifying a service and an impression target for the service.

26. The method of claim 25, further comprising creating a media plan for the non-ROS ad after the proposal for the non-ROS ad is approved.

27. The method of claim 26, wherein the act of creating the media plan for the non-ROS ad comprises specifying a channel and an impression target for the channel.

28. The method of claim 23, further storing a placement rule and associating the placement rule with one of the non-ROS ads.

29. The method of claim 28, wherein the placement rule specifies that the ad is attracted to graphic content assets that have a particular predominate visual.

30. The method of claim 28, wherein the placement rule specifies that the ad is attracted to graphic content assets of a certain type.

31. An asset selection method, comprising:
selecting an advertisement, the selected advertisement being associated with meta-data;
transmitting the selected advertisement to one or more client devices;
after selecting the advertisement, selecting a graphical content asset, wherein the selection of the graphical content asset is based, at least in part, on the meta-data associated with the selected advertisement; and
after selecting the graphical content asset, transmitting the graphical content asset to the one or more client devices.

32. The method of claim 31, wherein the selected graphical content asset is transmitted to the one or more client devices prior to the selected advertisement being transmitted to the one or more client devices.

33. The method of claim 32, wherein the selected graphic content asset is associated with one or more placement rules.

34. The method of claim 33, wherein the selection of the graphical content asset is based, at least in part, on the meta-data associated with the selected advertisement and the one or more placement rules.

35. The method of claim 34, wherein the graphical content assets is a music video, song, interview or concert.

36. The method of claim 31, wherein the meta-data includes information concerning a subject matter of the advertisement.
